(19) United States
(12) Patent Application Publication
(10) Pub. No.: US 2023/0108189 A1
(43) Pub. Date: Apr. 6, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Kosuke TOMOKUNI, Kanagawa (JP); Yuki YAMANAKA, Kanagawa (JP)

(73) Assignee: FUJIFILM Business Innovation Corp., Tokyo (JP)

(21) Appl. No.: 17/714,157

(22) Filed: Apr. 6, 2022

(30) Foreign Application Priority Data
Oct. 1, 2021 (JP) 2021-162554

(51) Int. Cl. H04N 1/00; G06F 3/12

(52) U.S. Cl. CPC H04N 1/00949; G06F 3/1275; G06F 3/1204; G06F 3/1208

(57) ABSTRACT

An information processing apparatus includes a processor configured to: execute link processing that is a series of processing linked between plural functions according to a link script in which a processing order of each function of the plural functions, a processing content of each function, and an information transmission format between the functions are set; and create a new link script by correcting, in setting content of the link script, the setting content of a part different from a part changed by a user such that a link between the functions is available in a case where the link between the functions is not available because the part of the setting content of the link script is changed by the user, in which the new link script processes the same link processing as the link script.

### CROSS-REFERENCE TO RELATED APPLICATIONS

This application is based on and claims priority under 35 USC 119 from Japanese Patent Application No. 2021-162554 filed Oct. 1, 2021.

### BACKGROUND

### (i) Technical Field

The present invention relates to an information processing apparatus, a non-transitory computer readable medium storing a program, and an information processing method.

### (ii) Related Art

JP2009-009567A discloses a service image processing system including an information processing apparatus and an image processing apparatus, the information processing apparatus including generation means for generating script data for performing service processing on document data and script data transmission means for transmitting the script data generated by the generation means to the image processing apparatus, and image processing apparatus including interpretation means for interpreting content of the script data transmitted by the script data transmission means and service processing means for performing service processing on the document data transmitted from the information processing apparatus based on the interpretation result of the interpretation means.

### SUMMARY

A system that executes link processing which is a series of processing linked between a plurality of functions according to a link script has been proposed. In the link script, a processing order of each function, a processing content in each function, an information transmission format between the functions, and the like are set. In the system, a user may change content of the existing link script.

However, when changing the content of the link script, unless the user sets a setting value and an information transmission format in each processing such that there is no inconsistency between the functions, a series of link processing may not be correctly executed. For this reason, the user who changes the link script needs to clearly recognize the processing content of each function that performs link processing.

Aspects of non-limiting embodiments of the present disclosure relate to an information processing apparatus, a non-transitory computer readable medium storing a program, and an information processing method that can change a link script in a system executing a series of link processing between a plurality of functions according to the link script even in a case where a user does not recognize processing content of each function which performs link processing.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: execute link processing that is a series of processing linked between a plurality of functions according to a link script in which a processing order of each function of the plurality of functions, a processing content of each function, and an information transmission format between the functions are set; and create a new link script by correcting, in setting content of the link script, the setting content of a part different from a part changed by a user such that a link between the functions is available in a case where the link between the functions is not available because the part of the setting content of the link script is changed by the user, in which the new link script processes the same link processing as the link script.

### BRIEF DESCRIPTION OF THE DRAWINGS

Exemplary embodiment(s) of the present invention will be described in detail based on the following figures, wherein:

FIG. 1 is a block diagram illustrating a configuration of a data processing system according to a first exemplary embodiment of the present invention;

FIG. 2 is a block diagram illustrating a hardware configuration of a script management server according to the first exemplary embodiment of the present invention;

FIG. 3 is a diagram illustrating a script editor screen displayed by a GUI of a script editor;

FIG. 4 is a diagram illustrating a description example of a script according to the first exemplary embodiment;

FIG. 5 is a diagram illustrating a flow of data in a workflow indicated by the script;

FIG. 6 is a diagram illustrating a flow of data in a workflow indicated by the corrected script;

FIG. 7 is a flowchart illustrating a procedure of script recreation processing according to the first exemplary embodiment;

FIG. 8 is a sub flowchart of the flowchart of FIG. 7;

FIG. 9 is a diagram illustrating data types of scan data that can be processed by each processing in the workflow indicated by the script;

FIG. 10 is a diagram illustrating data types of scan data that can be processed by each processing in the workflow indicated by the corrected script;

FIG. 11 is a flowchart illustrating a procedure of script recreation processing according to a second exemplary embodiment;

FIG. 12 is a sub flowchart of the flowchart of FIG. 11;

FIG. 13 is a diagram illustrating data types of scan data in each processing in the workflow indicated by the script recreated by a script creation server; and

FIG. 14 is a diagram illustrating a description example of the script according to the second exemplary embodiment.

### DETAILED DESCRIPTION

Hereinafter, exemplary embodiments of the present invention will be described in detail with reference to the accompanying drawings.

First Exemplary Embodiment

System Configuration

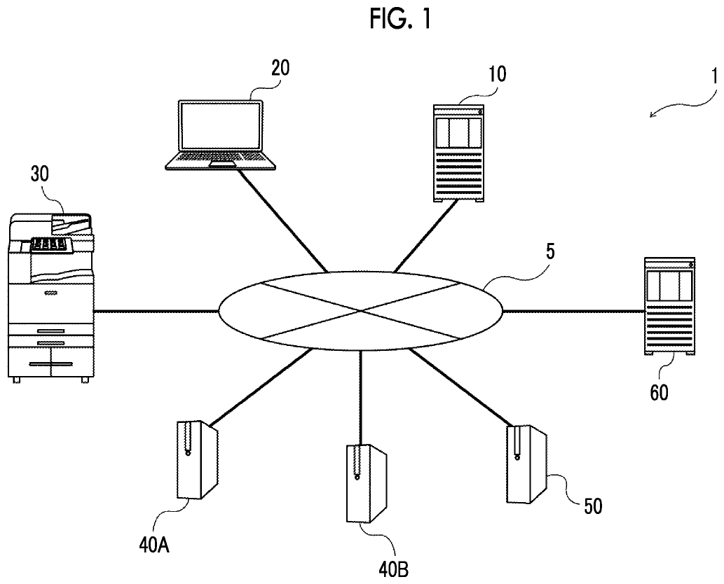

FIG. 1 is a block diagram illustrating a configuration of a data processing system 1 according to a first exemplary embodiment of the present invention.

In the data processing system 1, apparatuses and application programs that perform various services are connected via a network 5. In the data processing system 1, link processing (hereinafter, referred to as “workflow”), which is a series of processing linked between a plurality of services, can be executed according to a link script (hereinafter, referred to as “script”) in which a processing order of each service of a plurality of services, a processing content of each service, and an information transmission format between the services are set.

Here, the services refer to functions that are available in the data processing system 1, such as functions that are available for data such as a text or an image, or utility functions such as an alarm and a scheduler. The services include, for example, copy, print, scan, facsimile transmission/reception, mail delivery, data input to a repository and data reading from a repository, optical character recognition (OCR) processing, noise removal processing, an alarm, a scheduler, and the like. The services are not particularly limited thereto.

Specifically, the data processing system 1 includes a script management server 10, a terminal apparatus 20, an image forming apparatus 30, an OCR service providing server 40A, an OCR service providing server 40B, an image processing apparatus 50, and a core system 60.

The script management server 10 performs creation and management of a script, links the services according to the script, and executes a workflow.

The terminal apparatus 20 includes a user interface for performing an instruction for creation of the script, an instruction for execution of the script, and the like.

The image forming apparatus 30 is a so-called multifunction apparatus having a plurality of functions such as a printing function, a scanning function, a copying function, and a facsimile function.

The OCR service providing server 40A and the OCR service providing server 40B have an OCR function.

The image processing apparatus 50 has image processing functions for performing various image processing such as image noise removal processing, image rotation processing, and image data conversion processing.

The core system 60 has a function as a repository, and manages various data output from the image forming apparatus 30, the OCR service providing servers 40A and 40B, the image processing apparatus 50, and the like.

In the present exemplary embodiment, the data processing system 1 has a configuration in which a plurality of servers that perform predetermined service processing are connected via the network 5. On the other hand, the present exemplary embodiment is not particularly limited to the configuration as long as a plurality of services are connected via the network 5.

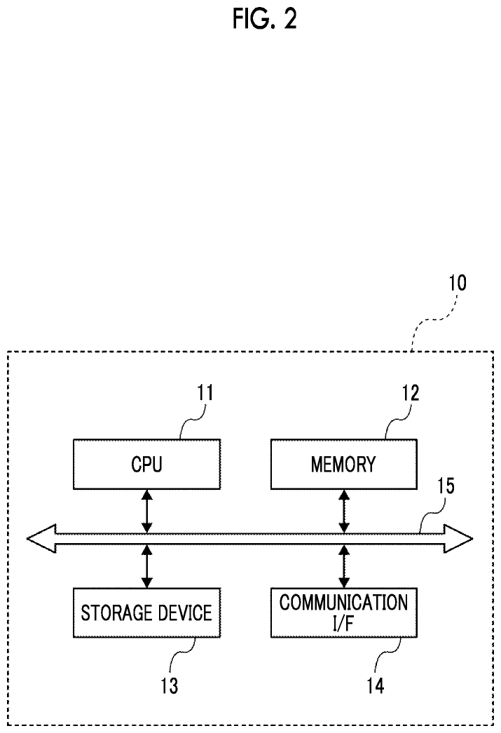

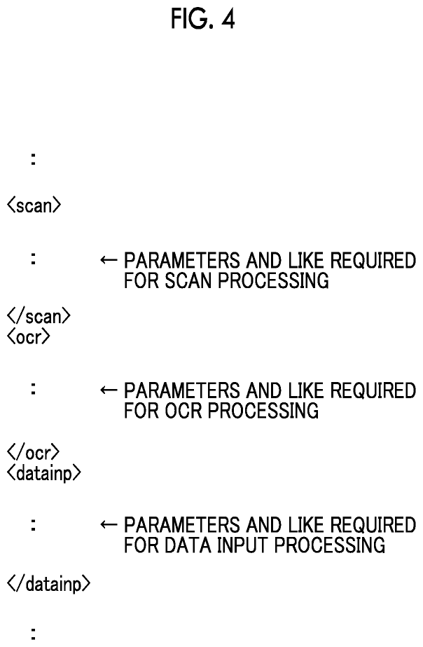

The script management server 10 is an example of an information processing apparatus according to the exemplary embodiment of the present invention, and as illustrated in FIG. 2, includes a central processing unit (CPU) 11, a memory 12, a storage device 13 such as a hard disc drive, and a communication interface (in FIG. 4, described as “I/F”) 14 for transmitting and receiving data to and from an external apparatus. These components are connected to each other via a control bus 15.

The CPU 11 is a processor that controls an operation of the script management server 10 by executing predetermined processing based on a program stored in the memory 12 or the storage device 13. In the present exemplary embodiment, an example in which the CPU 11 reads and executes a program stored in the memory 12 or the storage device 13 is described. On the other hand, the present exemplary embodiment is not limited thereto. The program may be provided by being recorded on a computer-readable recording medium, for example, an optical disc such as a compact disc read only memory (CD-ROM) or a digital versatile disc read only memory (DVD-ROM), or a semiconductor memory such as a Universal Serial Bus (USB) memory or a memory card. In addition, the program may be acquired from an external apparatus via a communication line connected to the communication interface 14.

Further, the storage device 13 stores “information on services that are available to a user”, “information in previous creation of a new script”, and the like. The “information on services that are available to a user” is information on services that are available to a user in the data processing system 1, such as services realized by software owned by a user and services contracted by a user. Further, the “information in previous creation of a new script” is information in a case where the CPU 11 previously creates a new script according to a change in setting content of the script by a user. The information may include, for example, information on the setting content, a correction method selected by the user in a case where there are a plurality of correction methods for one item, and the like. A case where the CPU 11 recreates the script will be described in detail later.

In a case of creating a script, the CPU 11 acquires detailed information required to create the script from various apparatuses such as the image forming apparatus 30, the OCR service providing server 40A, the OCR service providing server 40B, and the core system 60 which are connected to the network 5.

Here, the detailed information required to create the script includes, for example, “service type”, “service name”, “service location”, “input information”, “output information”, and the like.

The “service type” is information indicating a processing content of the service provided by various apparatuses connected to the network 5. The “service type” includes predefined service types, for example, copy, print, scan, facsimile transmission/reception, mail delivery, data input to a repository, data reading from a repository, alarm, scheduler, and the like. On the other hand, the service type is not limited thereto.

The “service name” is information indicating a name of the service provided by various apparatuses. The “service location” is information indicating a destination of an access to an apparatus that provides the service, and is, for example, a uniform resource locator (URL) used in a case of using the service. The “input information” is information on a type and a requirement of data to be input to the service. The “output information” is information on a type and a requirement of data to be output from the service.

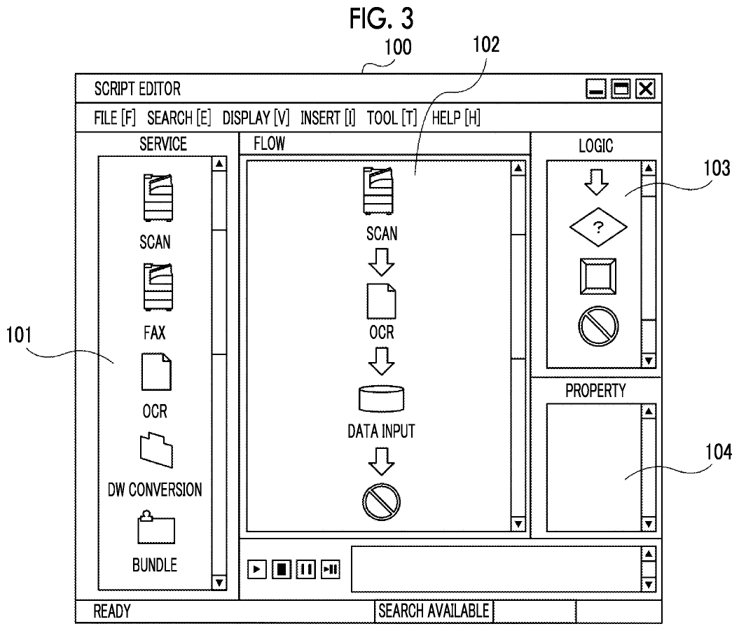

FIG. 3 is a diagram illustrating a script creation screen 100 which is a GUI screen for defining a workflow. The script creation screen 100 includes a service window 101, a flow window 102, a logic window 103, and a property window 104.

The service window 101 displays various service processing apparatuses that can be used. The logic window 103 displays a workflow indicating a pattern of a link between services. The property window 104 displays detailed setting parameters of each icon displayed in the service window 101 and the logic window 103.

A system administrator or a general user can define a workflow in the flow window 102 by dragging and dropping an icon of the service window 101 and an icon of the logic window 103 into the flow window 102. Further, the user can set a detailed relationship between the services such as services and logics by editing a content displayed in the property window 104.

In the flow window 102 of FIG. 3, as an example, a workflow for performing OCR processing on scanned image data and inputting, as data, a specific text string in an scanned image and OCR data into a repository is defined.

In this way, the administrator or the user defines a workflow by dragging and dropping an icon of the service window 101 and an icon of the logic window 103 into the flow window 102. In addition, the administrator or the user edits a content displayed in the property window 104. By such an operation, it is possible to easily create a script for linking various and complicated processing.

FIG. 4 illustrates an outline of a description example of a part of a script. The description example illustrated in FIG. 4 is merely an example, and the present exemplary embodiment is not limited thereto. The example illustrated in FIG. 4 is a description example of a script in a case of the workflow illustrated in FIG. 3. The workflow of FIG. 3 is a workflow for generating text data of a document included in a scanned image by performing OCR processing on scanned image data and inputting, as data, the scanned image and a specific text string in the text data into a repository.

As illustrated in FIG. 4, a content of scan processing is defined by parameters described between a start tag <scan> and an end tag </scan> for instructing the scan processing. As the parameters of the scan processing, for example, a service name, a reading resolution, a save file format, and the like for performing the scan processing are described.

Similarly, a content of OCR processing is defined by parameters described between a start tag <OCR> and an end tag </OCR> for instructing the OCR processing. As the parameters of the OCR processing, for example, a service name, a save file format, and the like for performing the OCR processing are described.

Further, data input processing is defined by parameters described between a start tag <datainp> and an end tag </datainp> for instructing the data input processing. As the parameters of the data input processing, for example, a repository name to be a target of the data input processing, an input information acquisition source for each item, and the like are described.

The script describes all the information on a control of the workflow. Thereby, the workflow itself represented by the script is also regarded as one service. The script is not limited to the configuration illustrated in FIG. 3, and is sufficient as long as the script can link the services.

Further, in a case where the script is executed, the CPU 11 executes the workflow by interpreting the script and sequentially calling various apparatuses connected to the network 5 according to an order and a using method described in the script.

Script Recreation Processing in Script Management Server

Since a script needs to define a series of processing to be linked between a plurality of functions, a creator of a script needs to clearly recognize a processing content of each function that performs link processing. For this reason, it is difficult for a general user to create a script from the beginning. From the above, it is assumed that the system administrator creates a script in advance and saves the script as a template in the script management server 10 and that the user selects and executes a desired script from the scripts stored in the script management server 10.

At this time, the user can use the selected script as it is, or can edit a part of the selected script and use the edited script.

As an example, as illustrated in FIG. 3, a case where the user selects a script of a workflow will be described, the workflow being a workflow for generating text data of a document included in a scanned image by performing OCR processing on data of the scanned image and inputting, as data, a specific text string in the scanned image and the text data into a repository.

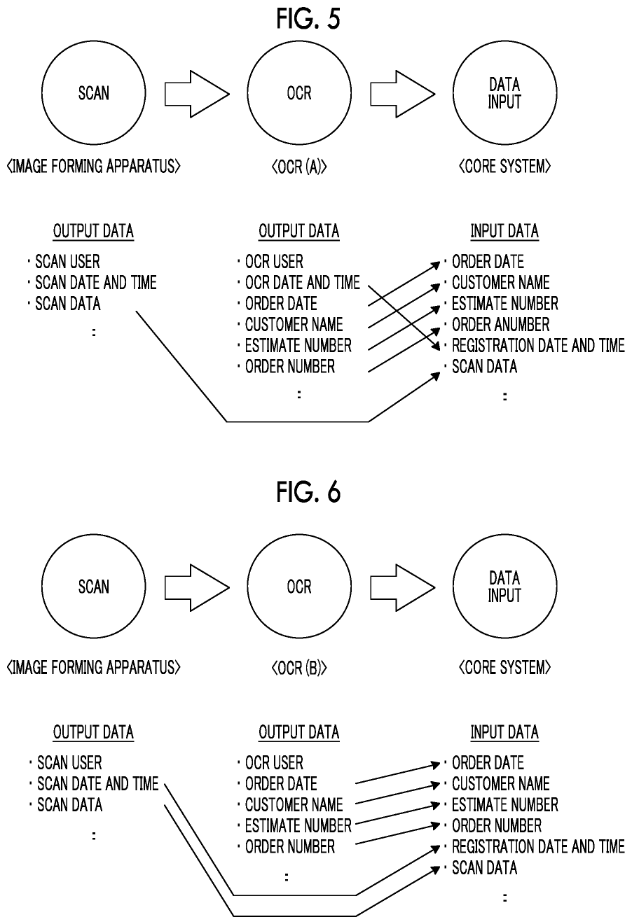

In detail, as illustrated in FIG. 5, in a case of a workflow indicated by a script, first, in the image forming apparatus 30, data such as “scan user”, “scan date and time”, and “scan data” are output by performing scanning on an order slip. The data output from the image forming apparatus 30 is transmitted to the OCR service providing server 40A (referred to as “OCR (A)” in FIG. 5 and subsequent drawings) via the script management server 10.

Next, in the OCR (A), “OCR user” and “OCR date and time” are output by performing OCR processing on the scan data of the order slip scanned by the image forming apparatus 30. Further, in OCR (A), data such as “order date”, “customer name”, “estimate number”, and “order number” are extracted and output from data obtained by performing OCR processing on the scan data of the order slip. The data output from the OCR (A) is transmitted to the core system 60 which is a repository via the script management server 10.

Finally, data such as “order date”, “customer name”, “estimate number”, “order number”, “registration date and time”, and “scan data” is input and stored in the core system 60. Here, from the data output by the OCR (A), “order date”, “customer name”, “estimate number”, and “order number” are respectively input to items of “order date”, “customer name”, “estimate number”, and “order number”. Further, from the data output by the OCR (A), “OCR date and time” is input to an item of “registration date and time”. Further, from the data output by the image forming apparatus 30, “scan data” is input to an item of “scan data”.

For the script, as illustrated in FIG. 6, it is assumed that the user changes the server which performs OCR processing from the OCR service providing server 40A to the OCR service providing server 40B (referred to as “OCR (B)” in FIG. 6 and subsequent drawings).

It is assumed that the OCR (B) outputs, as output data, data such as “OCR user”, “order date”, “customer name”, “estimate number”, and “order number” by performing OCR processing on the scan data scanned by the image forming apparatus 30 and does not output “OCR date and time”.

In this case, for the item of “registration date and time” which is input to the core system 60, “OCR date and time” cannot be acquired from the OCR (B). As a result, the workflow cannot be completed.

As described above, in a case where a user, who does not clearly recognize the processing content of each service that performs the workflow, edits a part of the script, a link between the services may not be available.

The present exemplary embodiment is for dealing with such a problem. Specifically, in a case where the link between the services is not available because a part of the setting content of the script is changed by the user, the CPU 11 of the script management server 10 creates a new script by correcting, in the setting content of the script, the setting content of a part different from the part changed by the user such that the link between the services is available.

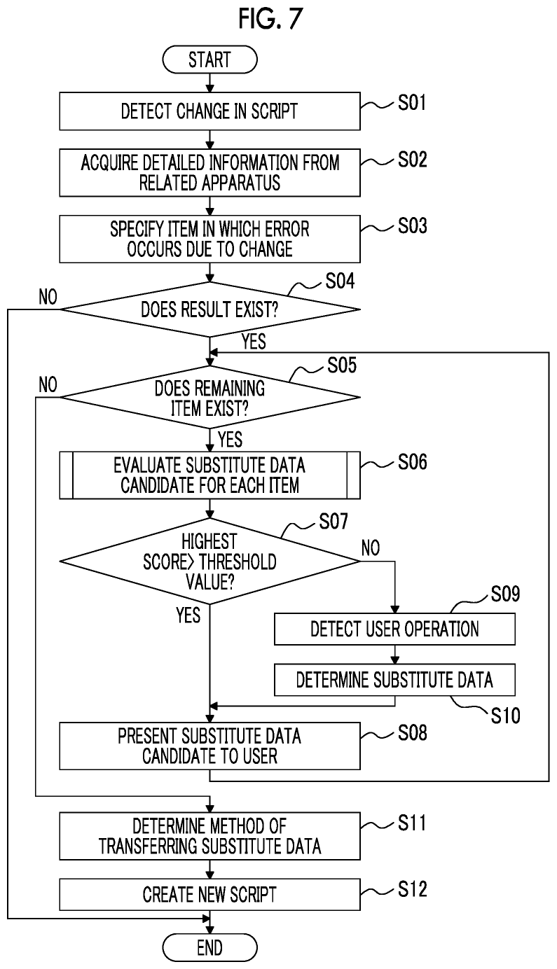

FIG. 7 is a flowchart illustrating a processing procedure in a case where the script is recreated by the CPU 11 of the script management server 10.

In a case where the CPU 11 detects a change in the script in step S01, in step S02, the CPU 11 acquires detailed information required for creating the script from the apparatus related to the workflow indicated by the script.

Next, in step S03, the CPU 11 specifies, in the changed script, whether an item in which an error occurs due to the change exists. Specifically, as in the example illustrated in FIG. 6, an item for which data cannot be normally transferred is specified.

In step S04, the CPU 11 determines whether or not a result specified in step S03 (that is, an item in which an error occurs) exists. In a case where it is determined that a specified result does not exist (determination result: No), the processing is ended because there is no problem in the changed script.

In a case where it is determined in step S04 that a specified result exists (determination result: Yes), in step S05, the CPU 11 determines whether or not an item for which substitute data is not determined (referred to as “remaining item” in FIG. 7 and subsequent drawings) exists in the items n which an error occurs.

In a case where it is determined in step S05 that a remaining item exists (determination result: Yes), in step S06, the CPU 11 evaluates a substitute data candidate for each item.

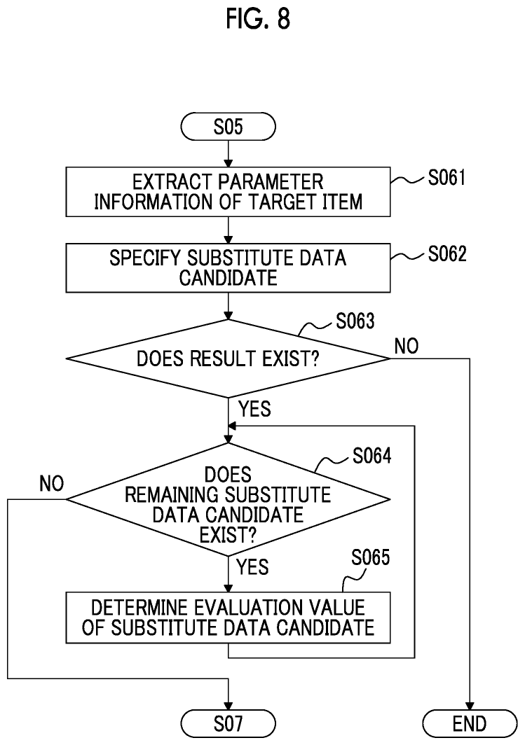

Here, details of processing of step S06 will be described with reference to a flowchart of FIG. 8.

First, in step S061, the CPU 11 extracts parameter information of a target item. Next, in step S062, the CPU 11 specifies, as a substitute data candidate, in the workflow indicated by the script, data similar to the parameter information extracted in step S061, from the data output by the service processing apparatus in a stage prior to the target item.

For example, in the example illustrated in FIG. 6, since “OCR date and time” to be input to the core system 60 cannot be acquired from the OCR (B), from the data output by the image forming apparatus 30 that performs scan processing in a stage prior to the OCR processing, “scan date and time”, which is data similar to “OCR date and time”, is specified as a substitute data candidate. In the example, data indicating the date and time is only “scan date and time”. On the other hand, in a case where there are a plurality of pieces of data indicating the date and time, the plurality of pieces of data are specified as substitute data candidates.

In step S063, the CPU 11 determines whether or not a result specified in step S062 (that is, a substitute data candidate) exists. In a case where it is determined that a specified result does not exist (determination result: No), the processing is ended because the script cannot be recreated.

In a case where it is determined in step S063 that a specified result exists (determination result: Yes), in step S064, the CPU 11 determines whether or not a substitute data candidate for which an evaluation value to be described later is not determined (referred to as “remaining substitute data candidate” in FIG. 8 and subsequent drawings) exists.

In a case where it is determined in step S064 that a remaining substitute data candidate exists (determination result: Yes), in step S065, the CPU 11 determines an evaluation value for each substitute data candidate. As an example, as the substitute data candidate is more similar to the parameter information of the target item, the evaluation value is set to be higher. A method of determining the evaluation value is not particularly limited. For example, the evaluation value may be determined as follows.

In the above example, the substitute data candidate for “OCR date and time” is only the scan date and time. On the other hand, in a case where there are a plurality of substitute data candidates for “OCR date and time”, for the substitute data candidates for “OCR date and time”, the evaluation values may be determined as follows. For example, it is considered that the processing closer to the target item in the order of the workflow represents the date and time closer to “OCR date and time”. Thus, as compared with the date and time data of the processing farther from the target item, for the date and time data of the processing closer to the target item, a higher evaluation value may be determined. Further, it is considered that the processing similar to the processing content of the target item represents the date and time closer to “OCR date and time”. Thus, as compared with the date and time data of the processing non-similar to the target item, for the date and time data of the processing similar to the target item, a higher evaluation value may be determined. In this case, by setting a category for each processing in advance, it is possible to determine that processing of the same category as the category of the target item is similar processing and that processing of the category different from the category of the target item is not similar processing. As the category, one category may be set for one processing, and a plurality of categories may be set for one processing. Thereby, it possible to determine a degree of similarity based on the number of matches of the categories. Further, the evaluation value of the substitute data candidate may be determined considering both whether or not the processing is close to the target item in the order of the workflow and whether or not the processing is similar to the processing content of the target item. In this case, for example, as the processing is more similar to the processing content of the target item and is closer to the target item in the order of the workflow, a higher evaluation value may be determined.

In a case where the OCR date and time is expressed in eight digits of “YYYY(year)/MM(month)/DD(day)”, the eight-digit date and time data may have a higher evaluation value as compared with date and time data expressed in six digits of “YY/MM/DD” or date and time data expressed in four digits of “MM/DD”.

In a case where there are a plurality of substitute data candidates, the CPU 11 repeats processing of step S064 and step S065 until the evaluation values of all the substitute data candidates are determined. In a case where it is determined in step S064 that a remaining substitute data candidate does not exist (determination result: No), the CPU 11 proceeds to step S07 of the flowchart of FIG. 7.

In step S07, the CPU 11 determines whether or not a highest score of the evaluation value of the substitute data candidate exceeds a predetermined threshold value. In a case where it is determined that a highest score exceeds a predetermined threshold value (determination result: Yes), in step S08, the CPU 11 determines, as substitute data, the substitute data candidate having the highest score, and proceeds to step S05.

In a case where it is determined in step S07 that the highest score does not exceed the predetermined threshold value (determination result: No), in step S09, the CPU 11 presents all the substitute data candidates to the user and allows the user to select a certain substitute data candidate. Next, in a case where the CPU 11 detects a user operation for selecting a substitute data candidate in step S10, in step S08, the CPU 11 determines, as substitute data, the substitute data candidate selected by the user, and proceeds to step S05.

In a case where there are a plurality of items in which an error occurs, the CPU 11 repeats steps from step S05 to step S10 until pieces of substitute data for all the items are determined. In a case where it is determined in step S05 that a remaining item does not exist (determination result: No), in step S11, the CPU 11 determines a method of transferring the substitute data.

The method of transferring the substitute data is not particularly limited. For example, since all the data output from each processing is stored in the memory of the script management server 10, the substitute data stored in the memory of the script management server 10 may be transmitted to the apparatus that performs the target processing.

Further, for example, as additional information of a data file such as scan data, the substitute data may be included in the data file, and a comma separated values (CSV) file or the like in which the substitute data is recorded may be transmitted together with the data file.

Finally, in step S12, the CPU 11 creates a new script based on the content determined in step S01 to step S11, and the processing is ended.

For creation of a new script, as in the above example, a case where the script in which the workflow illustrated in FIG. 5 is defined is changed from the OCR (A) to the OCR (B) by the user as illustrated in FIG. 6 will be described.

In this case, in the script illustrated in FIG. 4, in the parameters of the item of OCR processing, the apparatus that performs OCR processing is changed from the OCR (A) to the OCR (B) by the change by the user. In accordance with the change, the CPU 11 corrects, from input information acquisition destinations in the parameters of the data input processing item, data to be input to the “registration date and time” item, to “scan date and time” output from the image forming apparatus 30, instead of “OCR date and time”.

As a result, in the new script in which the setting content is corrected, “scan date and time” output from the image forming apparatus 30 is transmitted to the core system 60, as substitute data, instead of “OCR date and time”.

As described above, in a case where the link between the services is not available because a part of the setting content of the script is changed by the user, the CPU 11 creates a new script by correcting, in the setting content of the script, the setting content of a part different from the part changed by the user such that the link between the services is available. Thereby, it is possible to change the script even though the user does not recognize the processing content of each service that performs the workflow.

Further, the CPU 11 creates a new script, in a case where a link between the services is not available because a part of setting content of the script is changed by a user, by changing an information transmission format between the services for which the link is not available. Thereby, even in a case where the link between the services is not available because the user edits a part of the script, it is possible to restore the link between the services.

In the present exemplary embodiment, the CPU 11 may create a new script such that at least one of input information or output information in the entire workflow is not changed. Thereby, the script is corrected, and thus an influence on the system by the user can be suppressed.

Further, the CPU 11 may present, in creation of the new script, a plurality of correction methods to the user in a case where there are the plurality of correction methods for the setting content, according to a change in the setting content by the user. Thereby, it is possible to allow the user to select a certain correction method.

For example, in the flowchart illustrated in FIG. 7, in step S06 to step S10, the evaluation value is determined for each of the extracted substitute data candidates, and the substitute data candidate is presented to the user only in a case where it is determined that the highest score of the evaluation value does not exceed a predetermined threshold value. Instead of step S06 to step S10, all of the extracted substitute data candidates may be presented to the user, and the user may be allowed to select a certain substitute data candidate from the substitute data candidates.

Further, the CPU 11 may present a recommended correction method to the user by referring to information in previous creation of the new script, in a case where there are a plurality of correction methods for the setting content, according to a change in the setting content by the user. Thereby, it is possible to present information that may be used as a reference for the user's selection in a case where the user is allowed to select a certain correction method.

Further, the CPU 11 may present a recommended correction method to the user by referring to information in the services available to the user, in a case where there are a plurality of correction methods for the setting content, according to a change in the setting content by the user. Thereby, it is possible to present information that can be used as a reference for the user's selection in a case where the user is allowed to select a certain correction method.

Further, after creating a new script, the CPU 11 may execute a new workflow indicated by the new script, and acquire, from the user, information as to whether or not the new workflow is completed. Thereby, it is possible to ensure that new link processing indicated by the corrected new link script is completed.

In a case where a notification indicating that the new workflow is not completed is acquired from the user, the CPU 11 may present, to the user, a correction method for correcting the setting content to be different from the setting content corrected in creation of the new script. Thereby, in a case where the workflow is not completed, it is possible to allow the user to select another correction method.

In the above exemplary embodiment, in a case where there are a plurality of substitute data candidates, determination of the evaluation value of the substitute data candidate is repeatedly performed until the evaluation values of all the substitute data candidates are determined. On the other hand, the present invention is not necessarily limited to such an exemplary embodiment. For example, at a timing when a substitute data candidate having an evaluation value equal to or higher than a preset threshold value is detected, evaluation value determination of the remaining substitute data candidate may be omitted.

Second Exemplary Embodiment

In the first exemplary embodiment, an example in which the CPU 11 recreates a corrected new script, in a case where a link between the services is not available because a part of setting content of the script is changed by a user, by changing an information transmission format between the services for which the link is not available has been described.

In the present exemplary embodiment, an example in which the CPU 11 creates a corrected new script, in a case where a link between the services is not available because a part of setting content of the script is changed by a user, by adding a new service for complementing the services for which the link is not available will be described. Since the hardware configuration of the data processing system 1 according to the present exemplary embodiment is the same as the hardware configuration according to the first exemplary embodiment, a description thereof will be omitted.

Here, a case where the user selects the same script as in the first exemplary embodiment will be described. The workflow indicated by the script is a workflow for generating text data of a document included in a scanned image by performing OCR processing on data of the scanned image and inputting, as data, a specific text string in the scanned image and the text data into a repository.

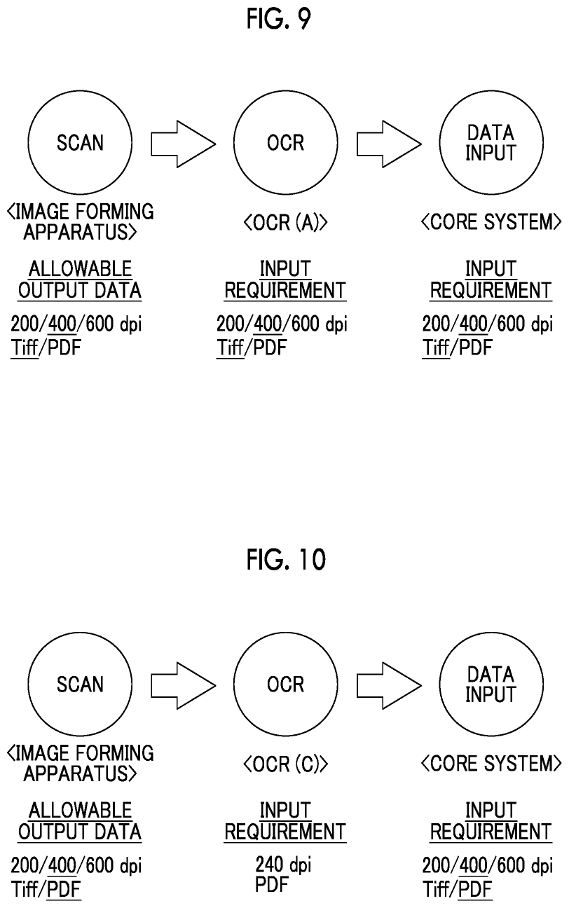

Details of the workflow are as the content illustrated in FIG. 5 described above, and thus a description thereof will be omitted. In the workflow, a requirement for a scan data file is as illustrated in FIG. 9.

The image forming apparatus 30 can output data of 200, 400, or 600 dots per inch (dpi) in a tagged image file format (Tiff) or a portable document format (PDF) as a scan data file format.

In the OCR (A), data of 200, 400, or 600 dpi in a Tiff format or a PDF format as a scan data file format can be input, the data being similar to the data of the image forming apparatus 30.

In the core system 60, data of 200, 400, or 600 dpi in a Tiff format or a PDF format as a scan data file format can also be input, the data being similar to the data of the image forming apparatus 30.

In the workflow indicated by the script illustrated in FIG. 9, it is defined that a Tiff file of 400 dpi which is output from the image forming apparatus 30 is received by the OCR (A) and the core system 60.

For the script, as illustrated in FIG. 10, it is assumed that the user changes the server which performs OCR processing from the OCR service providing server 40A to another OCR service providing server (referred to as “OCR (C)” in FIG. 10 and subsequent drawings).

In the OCR (C), a file input requirement is limited to a PDF file of 240 dpi. The input requirement does not correspond to any data of allowable output data of the image forming apparatus 30. In this case, the OCR (C) cannot acquire scan data from the image forming apparatus 30. Thus, the workflow cannot be completed.

In the present exemplary embodiment, in order to deal with such a problem, the CPU 11 of the script management server 10 creates a corrected new script by adding a new service such that the workflow is completed.

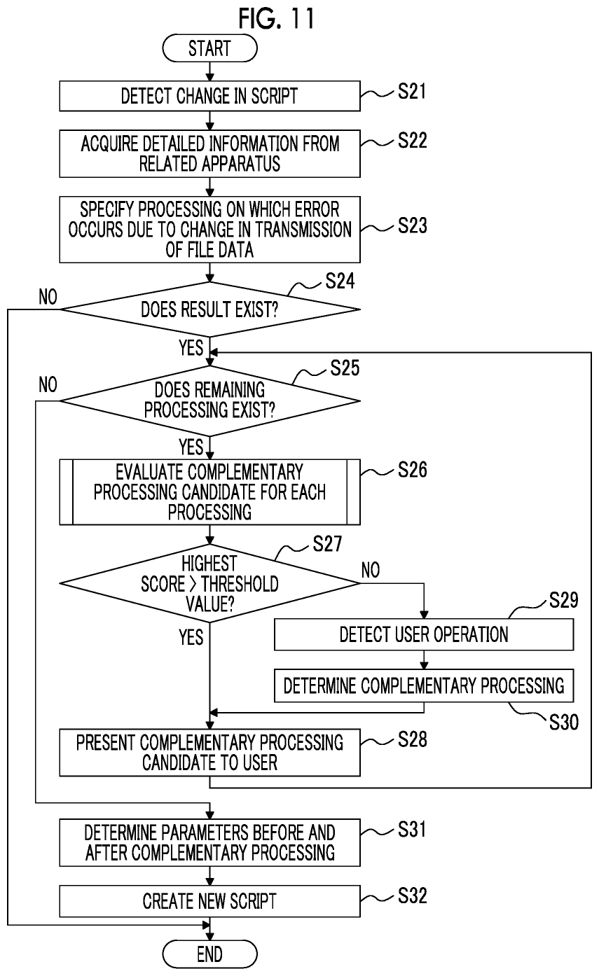

FIG. 11 is a flowchart illustrating a processing procedure in a case where the script is recreated by the CPU 11 of the script management server 10 according to the present exemplary embodiment.

In a case where the CPU 11 detects a change in the script in step S21, in step S22, the CPU 11 acquires detailed information required for creating the script from the apparatus related to the workflow indicated by the script.

Next, in step S23, the CPU 11 specifies, in the changed script, whether processing in which an error occurs in delivery of file data due to the change exists. Specifically, as in the example illustrated in FIG. 10, processing in which a file corresponding to the file data input requirement cannot be output for the subsequent processing is specified.

In step S24, the CPU 11 determines whether or not a result specified in step S23 (that is, processing in which an error occurs) exists. In a case where it is determined that a specified result does not exist (determination result: No), the processing is ended because there is no problem in the changed script.

In a case where it is determined in step S24 that a specified result exists (determination result: Yes), in step S25, the CPU 11 determines whether or not processing for which complement processing to be described later is not determined (referred to as “remaining processing” in FIG. 11 and subsequent drawings) exists in the processing in which an error occurs.

In a case where it is determined in step S25 that remaining processing exists (determination result: Yes), in step S26, the CPU 11 evaluates a complement processing candidate for each processing.

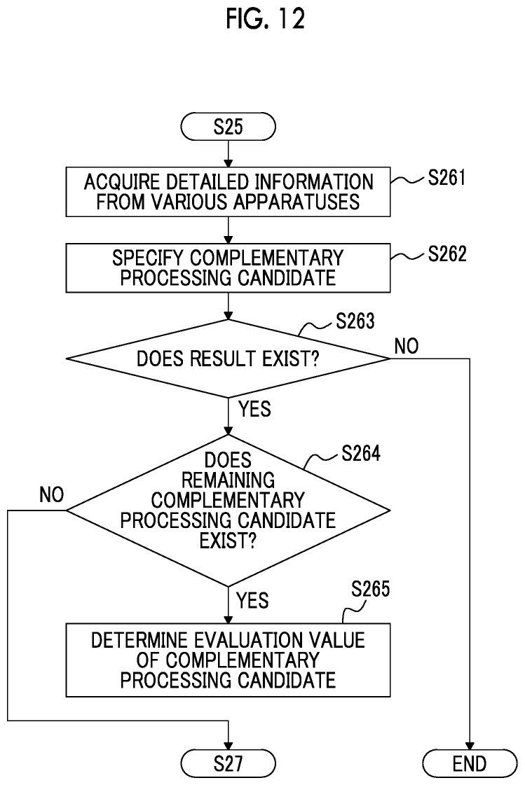

Here, details of processing of step S26 will be described with reference to a flowchart of FIG. 12.

First, in step S261, the CPU 11 acquires detailed information required for creating a script from various apparatuses connected to the network 5. Next, in step S262, for the file data which is output in the processing in which an error occurs in delivery of the file data, the CPU 11 specifies, from services provided by various apparatuses connected to the network 5, as a complement processing candidate, a service that can be converted so as to correspond to the file data input requirement in the subsequent processing.

For example, in the example illustrated in FIG. 10, in the OCR (C), a file input requirement is limited to a PDF file of 240 dpi. The file input requirement does not correspond to any data of allowable output data of the image forming apparatus 30.

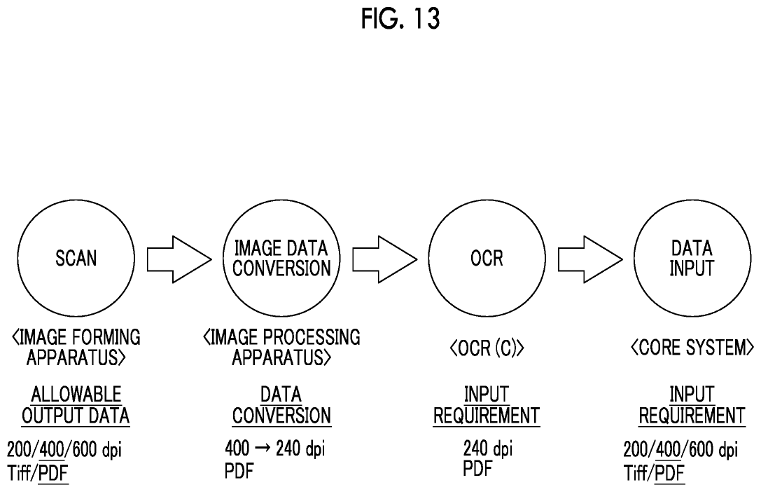

Thus, as illustrated in FIG. 13, for the file data which is output from the image forming apparatus 30, the CPU 11 specifies, as a complement processing candidate, a service that can be converted so as to correspond to the file data input requirement of the OCR (C) in the subsequent stage, that is, an image data conversion service provided by the image processing apparatus 50 connected to the network 5. In the example, the complement processing candidate is only the image data conversion service provided by the image processing apparatus 50. On the other hand, in a case where there are a plurality of services capable of performing the same processing, all the plurality of services are specified as complement processing candidates.

In step S263, the CPU 11 determines whether or not a result specified in step S262 (that is, a complement processing candidate) exists. In a case where it is determined that a specified result does not exist (determination result: No), the processing is ended because the script cannot be recreated.

In a case where it is determined in step S263 that a specified result exists (determination result: Yes), in step S264, the CPU 11 determines whether or not a complement processing candidate for which an evaluation value to be described later is not determined (referred to as “remaining complement processing candidate” in FIG. 12 and subsequent drawings) exists.

In a case where it is determined in step S264 that a remaining complement processing candidate exists (determination result: Yes), in step S265, the CPU 11 determines an evaluation value for each complement processing candidate. The method for determining the evaluation value is not particularly limited. For example, as an operating cost of the complement processing candidate is low, or as a quality of the complement processing is higher, a higher evaluation value is determined.

In a case where there are a plurality of complement processing candidates, the CPU 11 repeats processing of step S264 and step S265 until the evaluation values of all the complement processing candidates are determined. In a case where it is determined in step S264 that a remaining complement processing candidate does not exist (determination result: No), the CPU 11 proceeds to step S27 of the flowchart of FIG. 11.

In step S27, the CPU 11 determines whether or not a highest score of the evaluation value of the complement processing candidate exceeds a predetermined threshold value. In a case where it is determined that a highest score exceeds a predetermined threshold value (determination result: Yes), in step S28, the CPU 11 determines, as complement processing, the complement processing candidate having the highest score, and proceeds to step S25.

In a case where it is determined in step S27 that the highest score does not exceed the predetermined threshold value (determination result: No), in step S29, the CPU 11 presents all the complement processing candidates to the user and allows the user to select a certain complement processing candidate. Next, in a case where the CPU 11 detects a user operation for selecting a complement processing candidate in step S30, in step S28, the CPU 11 determines, as complement processing, the complement processing candidate selected by the user, and proceeds to step S25.

In a case where there are a plurality of pieces of processing in which an error occurs, the CPU 11 repeats steps from step S25 to step S30 until pieces of complement processing for all the pieces of processing are determined. In a case where it is determined in step S25 that remaining processing does not exist (determination result: No), in step S31, the CPU 11 determines parameters before and after the complement processing.

The method of determining the parameters is not particularly limited. For example, the parameters of other processing may be determined according to the processing with a most-limited requirement among pieces of processing included in the workflow.

As an example, in the workflow indicated by the script illustrated in FIG. 13, the OCR (C) can only input a PDF file of 240 dpi. Therefore, in the workflow, the image forming apparatus 30 in the previous stage outputs a PDF file of 400 dpi, which is similar to the data that can be input to the OCR (C), and the image processing apparatus 50 converts the PDF file of 400 dpi into a PDF file of 240 dpi and inputs the converted PDF file to the OCR (C). Further, in the core system 60, the PDF file of 400 dpi output from the image forming apparatus 30 is input.

Finally, in step S32, the CPU 11 creates a new script based on the content determined in step S21 to step S31, and the processing is ended.

For creation of a new script, as in the above example, a case where the script in which the workflow illustrated in FIG. 5 is defined is changed from the OCR (A) to the OCR (C) by the user as illustrated in FIG. 10 will be described.

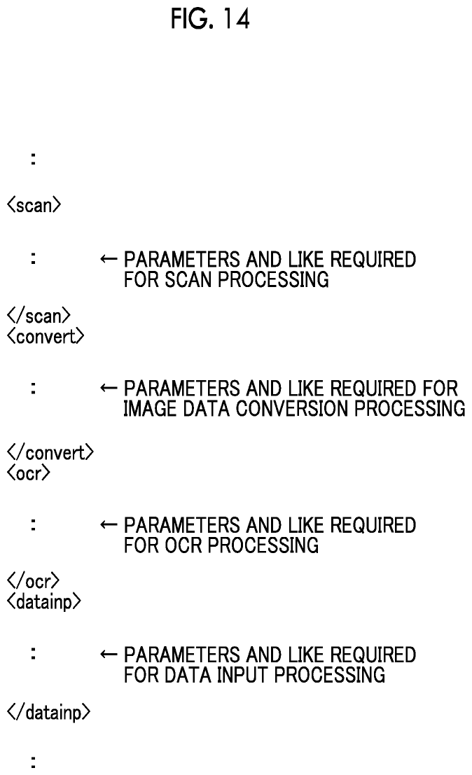

In this case, in the script illustrated in FIG. 4, in the parameters of the item of OCR processing, the apparatus that performs OCR processing is changed from the OCR (A) to the OCR (C) by the change by the user. In accordance with the change, as illustrated in FIG. 14, the CPU 11 performs correction for adding image data conversion processing between scan processing and OCR processing.

The image data conversion processing is defined by parameters described between a start tag <convert> and an end tag </convert> for instructing the image data conversion processing. As the parameters of the image data conversion processing, for example, a service name, conversion processing content, and the like for performing the image data conversion processing are described.

As a result, in the new script in which the setting content is corrected, the scan data output from the image forming apparatus 30 is converted into a format that can be input to the OCR (C) by the image processing apparatus 50, and the converted scan data is input to the OCR (C). Thereby, even in a case where the link between the services is not available because the user edits a part of the script, it is possible to restore the link between the services.

In the above exemplary embodiment, in a case where there are a plurality of complement processing candidates, determination of the evaluation value of the complement processing candidate is repeatedly performed until the evaluation values of all the complement processing candidates are determined. On the other hand, the present invention is not necessarily limited to such an exemplary embodiment. For example, at a timing when a complement processing candidate having an evaluation value equal to or higher than a preset threshold value is detected, evaluation value determination of the remaining complement processing candidate may be omitted.

Modification Example

As described above, an image forming system according to an exemplary embodiment of the present invention has been described. On the other hand, the present invention is not limited to the above exemplary embodiment, and may be appropriately modified.

For example, each part such as the server connected to the network 5 described above may be configured as an independent apparatus, some parts may be collectively provided in one apparatus, or all parts may be provided in one apparatus.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Further, in the embodiments above, a case where the present invention is applied to the image forming apparatus has been described. On the other hand, the present invention is not limited thereto, and various apparatuses may be used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
execute link processing that is a series of processing linked between a plurality of functions according to a link script in which a processing order of each function of the plurality of functions, a processing content of each function, and an information transmission format between the functions are set; and
create a new link script by correcting, in setting content of the link script, the setting content of a part different from a part changed by a user such that a link between the functions is available in a case where the link between the functions is not available because the part of the setting content of the link script is changed by the user,
wherein the new link script processes the same link processing as the link script.

2. The information processing apparatus according to claim 1, wherein the processor is configured to:
create the new link script by changing the information transmission format between the functions for which the link is not available in a case where the link between the functions is not available because the part of the setting content of the link script is changed by the user.

3. The information processing apparatus according to claim 1, wherein the processor is configured to:
create the new link script by adding a new function of complementing the functions for which the link is not available in a case where the link between the functions is not available because the part of the setting content of the link script is changed by the user.

4. The information processing apparatus according to claim 2, wherein the processor is configured to:
create the new link script by adding a new function of complementing the functions for which the link is not available in a case where the link between the functions is not available because the part of the setting content of the link script is changed by the user.

5. The information processing apparatus according to claim 1, wherein the processor is configured to:
create the new link script such that at least one of input information or output information in the link processing is not changed.

6. The information processing apparatus according to claim 2, wherein the processor is configured to:
create the new link script such that at least one of input information or output information in the link processing is not changed.

7. The information processing apparatus according to claim 3, wherein the processor is configured to:
create the new link script such that at least one of input information or output information in the link processing is not changed.

8. The information processing apparatus according to claim 4, wherein the processor is configured to:
create the new link script such that at least one of input information or output information in the link processing is not changed.

9. The information processing apparatus according to claim 1, wherein the processor is configured to:
present, in creation of the new link script, a plurality of correction methods to the user in a case where there are the plurality of correction methods for the setting content according to a change in the setting content by the user.

10. The information processing apparatus according to claim 2, wherein the processor is configured to:
present, in creation of the new link script, a plurality of correction methods to the user in a case where there are the plurality of correction methods for the setting content according to a change in the setting content by the user.

11. The information processing apparatus according to claim 3, wherein the processor is configured to:
present, in creation of the new link script, a plurality of correction methods to the user in a case where there are the plurality of correction methods for the setting content according to a change in the setting content by the user.

12. The information processing apparatus according to claim 4, wherein the processor is configured to:
present, in creation of the new link script, a plurality of correction methods to the user in a case where there are the plurality of correction methods for the setting content according to a change in the setting content by the user.

13. The information processing apparatus according to claim 5, wherein the processor is configured to:
present, in creation of the new link script, a plurality of correction methods to the user in a case where there are the plurality of correction methods for the setting content according to a change in the setting content by the user.

14. The information processing apparatus according to claim 6, wherein the processor is configured to:
present, in creation of the new link script, a plurality of correction methods to the user in a case where there are the plurality of correction methods for the setting content according to a change in the setting content by the user.

15. The information processing apparatus according to claim 9, wherein the processor is configured to:
present a recommended correction method to the user by referring to information in previous creation of the new link script, in a case where there are the plurality of correction methods for the setting content according to the change in the setting content by the user.

16. The information processing apparatus according to claim 9, wherein the processor is configured to:
present a recommended correction method to the user by referring to information on the functions available to the user, in a case where there are the plurality of correction methods for the setting content according to the change in the setting content by the user.

17. The information processing apparatus according to claim 1, wherein the processor is configured to:
execute new link processing indicated by the new link script after creation of the new link script, and acquire, from the user, information as to whether or not the new link processing is completed.

18. The information processing apparatus according to claim 17, wherein the processor is configured to:
present, to the user, a correction method of correcting the setting content to be different from the setting content corrected in creation of the new link script, in a case where a notification indicating that the new link processing is not completed is acquired from the user.

19. A non-transitory computer readable medium storing a program causing a computer to execute a process comprising:
executing link processing that is a series of processing linked between a plurality of functions according to a link script in which a processing order of each function of the plurality of functions, a processing content of each function, and an information transmission format between the functions are set; and
creating a new link script by correcting, in setting content of the link script, the setting content of a part different from a part changed by a user such that a link between the functions is available in a case where the link between the functions is not available because the part of the setting content of the link script is changed by the user,
wherein the new link script processes the same link processing as the link script.

20. An information processing method comprising:
executing link processing that is a series of processing linked between a plurality of functions according to a link script in which a processing order of each function of the plurality of functions, a processing content of each function, and an information transmission format between the functions are set; and
creating a new link script by correcting, in setting content of the link script, the setting content of a part different from a part changed by a user such that a link between the functions is available in a case where the link between the functions is not available because the part of the setting content of the link script is changed by the user,
wherein the new link script processes the same link processing as the link script.
